(19) United States
(12) Patent Application Publication
(10) Pub. No.: US 2005/0079454 A1
(43) Pub. Date: Apr. 14, 2005

(54) Contrast enhancement materials containing non-PFOS surfactants

(76) Inventors: Leroy E. Best, Phoenix, AZ (US); James F. McElvania, Phoenix, AZ (US)

Correspondence Address: BIRCH STEWART KOLASCH & BIRCH, PO BOX 747, FALLS CHURCH, VA, 22040-0747, US

(21) Appl. No.: 10/683,298

(22) Filed: Oct. 14, 2003

(51) Int. Cl. G03C 5/18

(52) U.S. Cl. 430/486

(57) ABSTRACT

Disclosed is a CEM composition comprising (A) a photobleachable dye; (B) an organic polymer binder; (C) a surfactant, which does not contain perfluorooctanyl sulfonate (PFOS); and (D) a solvent.

### BACKGROUND OF THE INVENTION

Lithography in the production of integrated circuits is predominantly carried out by optical means. To reduce circuit dimensions, improved performance and increase yield, optical systems have provided the required resolution with each successive generation of circuit technology. The image resolution of projection lithographic systems was improved to the point that it approached the physical limits imposed by practical constraints on numerical aperture and wavelength. While further improvements in lithographic technology are possible, alternative avenues have been investigated.

For instance, to continue the reduction of minimum feature size achievable by optical techniques, it became necessary to alter some other aspect of the lithographic process for further improvements. One area in which further improvements are possible is in the photo process. Each photo is characterized by some degree of incident contrast necessary to produce patterns usable for subsequent processing. This minimum required contrast of illumination is referred to as the contrast threshold of the resist. With the improvement of photo technology came contrast enhancement materials (CEMs). Contrast enhancement is a microlithography technique, which extends the practical limits of optical lithography systems. It provides I-line, g-line and broadband improvement in resolution, depth of focus (DOF), process latitudes and reduced defects. This improvement allows the fabrication of new and denser integrated circuits without the required capital equipment investment.

Contrast Enhancement Material technology is used in a variety of industries to improve performance. Some typical examples are: manufacturing of IC's, manufacturing GaAs microwave ICs, MOFSET gate processing, electro-optic or optoelectronic devices, analog devices, semiconductor lasers, wireless & telecom products, metal 1/metal 2-0.8 um metal lines, and HBT.

A CEM is a photo bleachable solution, which is initially opaque to the exposure wavelength(s) but becomes nearly transparent upon exposure. The Contrast Enhancement Material is spin coated over softbaked positive photoresist. When the aerial image of a mask is incident upon the CEM layer, the regions of highest intensity corresponding to the clear areas of the mask are bleached at a faster rate than the lower intensity gray and dark areas on the mask. By adjusting the bleaching dynamics so that the absorption of the CEM layer is sufficiently high and the photospeeds of the CEM and photoresist layers are properly matched, it is possible to completely expose the underlying photoresist in the light areas before the CEM is bleached through in the dark areas. Thus, during the exposure an in-situ contact mask is formed in the CEM layer. The net effect is a higher contrast level of the aerial image used to expose the photoresist.

Recently, the Environmental Protection Agency (EPA) has found that certain chemical compounds are persistent in the environment and should therefore be discontinued. In particular, the EPA found that Perfluorooctyl Sulfonates (PFOS) are very persistent in the environment, have a strong tendency to accumulate in human and animal tissues and could potentially pose a risk to human health and the environment over the long term. Some surfactants used in various CEMs are therefore no longer commercially viable since these surfactants contained PFOS. There exists a need, therefore, to find different and more environmentally friendly surfactants for the CEM technology to utilize.

### SUMMARY OF THE INVENTION

The present invention relates to a new CEM composition comprising:
(A) a photobleachable dye;
(B) an organic polymer binder;
(C) a surfactant, which does not contain perfluorooctanyl sulfonate (PFOS); and
(D) solvent.

In one embodiment of the present invention, the surfactant is an ethoxylated acetylenic diol surfactant which does not contain PFOS. Preferably, the surfactant is an ethoxylated acetylenic diol, for instance, ethoxylated 2,4,7,9-tetramethyl-5-decyn-4,7-diol. This preferred surfactant is commercially available as Surfynol™ 465, by Air Products. In this embodiment, the solvent is water.

In another embodiment of the present invention, the surfactant is FC-4430 Fluororad™ Fluoropolymer available from 3M. An organic solvent is used in this embodiment.

### DETAILED DESCRIPTION OF THE INVENTION

The present invention relates to a contrast enhancement material composition, which comprises:
(A) a photobleachable dye;
(B) an organic polymer binder;
(C) a surfactant, which does not contain perfluorooctanyl sulfonate (PFOS); and
(D) a solvent.

The present composition also has superior stability, which is advantageous in that the shelf life of the composition is increased. For instance, when stored at 20° C. for 90 days, the composition retains 95%, preferably 98% of the original activity. Current formulations stored at recommend storage temperatures (2° C.-4° C., 35° F.-41° F.) have a shelf life of at least 90 days. The formulations of the present invention, under the same storage conditions, have a shelf life of 180 days. The new formulations at process temperatures (18° C.-24° C., 65° F.-75° F.) also show superior advances. The current formulations have a shelf life of 30 days while the new formulations have a shelf life of at least 90 days.

Shelf life is important due to the degradation of the photobleachable dye. With an extended shelf life, the degradation of the material over time is reduced which decreases the amount of variation in the production process and improves product yield. An extended shelf life also reduces the need to purchase and produce small lots of material which improves product consistency and manufacturing cost. Extended shelf life also, reduces the amount of material that is rendered useless due to end of shelf life.

Each of the ingredients of the present invention is described below:

A. Photobleachable Dye

Photobleachable dyes are incorporated into the present invention. The photobleachable dye is used as the active ingredient in the invention. The functional purpose is described above. Photobleachable dyes which can be utilized in the practice of the present invention include, but are not limited to nitrone based photobleachable dyes. For instance, alkylnitrones and aryl nitrones suitable for use in the present invention are disclosed in U.S. Pat. Nos. 4,859,789, 4,990,665, 5,002,993, 5,106,723, 4,702,996, 4,578,344, 4,677,049, and 5,108,874.

The following nitrones are illustrative of those which may be used in this invention:
α-(4-Diethylaminophenyl)-N-phenylnitrone, α-(4-Diethylaminophenyl-N-(4-ethoxycarbonylphenyl)nitrone, α-(4-Diethylaminophenyl)-N-(4-chlorophenyl)-nitrone, α-(4-Diethylaminophenyl)-N-(3,4-dichlorophenyl)-nitrone, α-(4-Diethylaminophenyl)-N-(4-carbethoxyphenyl)-nitrone, α-(4-Diethylaminophenyl)-N-(4-acetylphenyl)-nitrone, α-(4-Dimethylaminophenyl)-N-(4-cyanophenyl)-nitrone, α-(4-Methoxyphenyl)-N-(4-cyanophenyl)nitrone, α-(9-Julolidinyl)-N-phenylnitrone, α-(9-Julolidinyl)-N-(4-chlorophenyl)nitrone, α-[2-(1,1-Diphenylethenyl)]-N-phenylnitrone, and α-[2-(1-Phenylpropenyl)]-N-phenylnitrone.
   Particularly preferred nitrones include:
α-(4-Diethylaminophenyl)-N-phenylnitrone (Nitrone 388),
α-(4-Diethylaminophenyl)-N-(2-methyl-4-carboxyphenyl)nitrone (Nitrone 408),
α-(4-Dimethylaminophenyl)-N-(2-methyl-4-carboxyphenyl)nitrone (Nitrone 409),
α-(4-Diethylaminophenyl)-N-buthoxycarbonylphenyl)nitrone (Nitrone 420B), and
α-(4-Diethylaminophenyl)-N-(ethoxycarbonylphenyl)nitrone (Nitrone 420E).

Amounts of incorporation of the photobleachable dye range from about 1 to 30 parts by weight, preferably 4-15 parts by weight.

B. Organic Polymer Binder Resin

Inert organic polymer binders are also incorporated into the present composition. The binder is involved in the coating process. The binder allows the ability to coat a definable thickness of material which will reside on top of the photoresist. Varying customer application requirements demand the ability to coat a variety of material thicknesses. The inert polymer binder material provides the ability to spin coat the material of this invention at a users definable thickness.

Binders which can be utilized in the practice of the present invention include, but are not limited to, polymers such as copolymers of styrene and allyl alcohol, polystyrene, poly(methylmethacrylate), poly(.alpha.-methylstyrene), poly(vinylpyrrolidone), polyphenyleneoxide, vinylpyridine/styrene copolymers, acrylonitrile/butadiene copolymers, butylmethacrylic/isobutyl methacrylate copolymers, cellulose propionate and other hydrocarbon-soluble cellulose esters, ethyl cellulose and other hydrocarbon-soluble cellulose ethers, ethylene/vinyl acetate copolymers, polyacenaphthylene, poly(benzylmethacrylate), poly(ethyleneoxide), poly(2-hydroxyethylmethacrylate), poly(4-isopropylstyrene), polyallylalcohol, poly(hydroxypropylmethylcellulose), poly(methylcellulose), and poly(hydroxypropylcellulose), poly(chloroprene), poly(ethylene oxide), and poly(vinylpyrrolidone), acetal resins, acrylonitrile/butadiene copolymers.

Particularly preferred organic polymer binders include 1-vinyl-2-pyrrolidone-vinyl acetate copolymer available as Luviskol™ VA64 (a film forming copolymer of vinyl pyrrolidone and vinyl acetate from BASF), or polysaccharides such as Pullulan (manufactured by Hayashibara Company Limited).

Amounts of incorporation of the organic polymer binder range from about 1 to 30 parts by weight, preferably 5 to 15 parts by weight.

C. Surfactant (non-PFOS)

Surfactant is added to the present invention to improve the suitability for coating. For instance, surfactants promote the planarization of an applied liquid film of photoresist. A uniform coating across the wafer is very important. Also, the surfactant is selected so as to be environmentally acceptable. As discussed above, surfactants containing perfluorooctanyl sulfonate (PFOS) are to be avoided due to the environmental considerations.

The amount of the surfactant is usually from 0.001 to 2 parts by weight, and preferably from 0.01 to 1 parts by weight based on the solid components in the composition of the invention. These surfactants may be used singly or as a combination of two or more kinds thereof.

The use of the surfactant according to the present invention has surprisingly resulted in superior properties. For instance, the shelf life of the prepared compositions are increased, as compared to other conventional compositions.

C-1. Water-Based System

When the solvent for the system is water, useful surfactants include common nonionic surfactants such as polyoxyethylene alcohols, tristyrylphenols, nonyl or octyl phenols, esters, diesters, sorbitol esters, polyoxyethylene/propylene block copolymers, sorbitan fatty acid esters, polyoxyethylene sorbitan fatty acid esters, ethoxylated siloxanes, acetylenic diols, and polyglucosides.

Exemplary polyoxyethylene alkyl ethers include polyoxyethylene lauryl ether, polyoxyethylene stearyl ether, polyoxyethylene cetyl ether and polyoxyethylene oleyl ether. Exemplary polyoxyethylene alkylaryl ethers include polyoxyethylene octyl phenol ether and polyoxyethylene nonyl phenol ether. Exemplary sorbitan fatty acid esters include sorbitan monolaurate, sorbitan monopalmitate, sorbitan monostearate, sorbitan monooleate, sorbitan trioleate, and sorbitan tristearate. Exemplary polyoxyethylene sorbitan fatty acid esters include polyoxyethylene sorbitan monolaurate, polyoxyethylene sorbitan monopalmitate, polyoxyethylene sorbitan monostearate, polyoxyethylene sorbitan trioleate, and polyoxyethylene sorbitan tristearate. In each instance, PFOS surfactants are to be avoided.

Particularly preferred surfactants are acetylenic diols, in particular ethoxylated acetylenic diols. Most preferably, the surfactant is ethoxylated acetylenic diol is ethoxylated 2,4,7,9-tetramethyl-5-decyn-4,7-diol. A specifically preferred alternative surfactant is Surfynol™ 465 Surfactant (available from Air Products and Chemicals, Inc.).

C-2. Organic Solvent-Based Systems

When the system is based upon an organic solvent, the surfactant found to be most suitable is FC-4430 Flourad™ Fluorosurfactant, available from 3M. FC-4430 Flourad™ Fluorosurfactant (herein referred to as FC-4430) is a composition which contains the following:

| Ingredient | C.A.S. No. | Percent |
|---|---|---|
| Fluoroaliphatic Polymer Esters | TradeSecret | 85-95 |
| +(6391) | | |
| Polyether Polymer +(6417P) | TradeSecret | 5-10 |
| 1-methyl-2-pyrrolidinone | 872-50-4 | 1-2 |
| Toluene | 108-88-3 | <1 |

D. Solvent

D-1 Water-Based Systems

The water-based system utilizes water as a solvent, preferably de-ionized water. The amount of water ranges from 80-95 parts by weight, preferably 85-93 parts by weight.

D-2 Organic Solvent-Based Systems

The organic solvent-bases system utilizes organic solvents such as aromatic hydrocarbons, aliphatic hydrocarbons, halogenated aliphatic compounds, and alcohols. More specific but non-limiting examples include solvents such as toluene, xylene, ethylbenzene, chlorobenzene, cyclohexane, trichloroethylene, methyl chloroform, 1,2-dimethoxy ethane, di-(2-methoxy ethyl)ether, 1-methoxy-2-propyl acetate, 1,1,2,2-tetrachloroethane, 1-methoxy-2-ethyl acetate, dioxane, methylisobutyl ketone, cyclohexanone, butanol, in particular n-butanol, propanol, in particular isopropanol, ethylene glycol, propylene glycol, amylacetate, butylacetate, toluene, or combinations thereof. Preferred solvents include isopropanol, PGMEA (propylene glycol methyl ether acetate), ethyl benzene and n-butanol, and combinations thereof. Preferable combinations include isopropanol with PGMEA and ethyl benzene with n-butanol. The amount of organic solvent ranges from 80-95 parts by weight, preferably 85-93 parts by weight.

E. Optional Drying agent

According to the present invention, a drying agent is optionally incorporated in the above-described composition when a solvent-based system is involved. The drying agent may be liquid or solid. It should be inert to the aryl nitrone and, in general, should form non-deleterious materials upon interaction with the solvent. Thus, a solid, insoluble drying agent may interact with the solvent to form other solids; but for the most part, a liquid should not interact to form solids which precipitate from the composition. Preferably, liquid drying agents should react to form materials easily removed by volatilization upon further processing. When a polymer is also present in the composition, the drying agent should not deleteriously react with the polymer, although the use of a drying agent which reacts in some way with the polymer is not precluded so long as the reaction is reversible or harmless.

Illustrative drying agents are molecular sieves, silica gel and alkylalkoxysilanes such as those disclosed in U.S. Pat. No. 4,661,433 at column 3, lines 24-62.

The proportion of drying agent in the compositions of this invention is not critical and may be adjusted as necessary to inhibit hydrolytic decomposition of the nitrone (expand to photobleaching dye if appropriate). Most often, the weight ratio of drying agent to nitrone will be from about 0.25:1 to about 5.0:1. The drying agent is used for the solvent-based materials.

F. Other Components Used in the Invention

The composition of the invention can, if necessary, further comprising a dye, a pigment, plasticizer, other surfactant than those described above, a photosensitizer, a compound having up to two phenolic OH groups of accelerating the solubility in a developer. In some instances, a pH modifier may be added. For instance, DABCO (diazabicyclo octane) may be added to adjust the pH. A higher pH better dissolves the photobleachable dye. Antibacterial/antifungal materials may also be added to prevent the composition from growing unwanted bacteria or fungi. For instance, biocides such as Kathon (available from Rohm and Haas). may be added to prevent the material from growing bacteria. In some instance, an ion exchange resin is utilized to reduce the amount of metal. In some instances, it is beneficial to lower the amounts of sodium or iron. This will reduce metal layer corrosion.

Certain quantitative measurements are needed to verify the quality of the final products. These measurements include “Percent Solid Determination” and “Cannon-Fenske Viscosity (cts) Determination”. These are discussed below:

Percent Solid Determination

The % solids in the present composition is ultimately set by the requirements of the consumer. However, according to the present invention, the % solids range between about 1-35% solids (by weight) based upon the total weight of the composition. Preferably, the % solids (by weight) range between 12-28% solids by weight based upon the total weight of the composition.

The % solids are determined as follows:

Equipment and Materials: Vacuum oven, aluminum weighing pans, and an analytical balance.

Procedure:
1. Place an empty weighing pan on balance. Record the value in the WT. OF PAN column. Tare the balance with the weighing pan still in place.
2. Place 11.0 g+/−0.1 g of sample into the weighing pan. Record the value in the WT. OF SAMPLE column.
3. Perform steps 1 and 2 in triplicate.
4. Place the weighing pans into the vacuum oven. Set the vacuum pressure and oven temperature as defined in the appropriate work instruction.
5. When samples have been in oven for the prescribed time, turn off the vacuum and remove the weighing pans and allow to cool to room temperature for approximately 5 min.
6. Weigh the weighing pans and record the weights in the WT.AFTER OVEN column. Subtract the value in the WT.OF PAN column from the WT.AFTER OVEN column and record the result into the WT.REMAINING column. Divide the value in the WT.REMAINING by the value in the WT.OF SAMPLE column and record it in the % SOLIDS column.
7. The applicable formula is:
   % Solids=(WT. REMAINING/WT. OF SAMPLE)*100
   Cannon-Fenske Viscosity (cts) Determination

The viscosity of the present composition is ultimately set by the requirements of the consumer. However, according to the present invention, the viscosity ranges between about 0.5-25 cts. Preferably, the viscosity ranges between about 1.5-20 cts.

The viscosity is determined using the Cannon-Fenske system as follows:

Equipment and Materials: Cannon-Fenske Viscometer (size #100, 150, 200 . . . ), constant temperature water bath, stopwatch capable of 0.1 second accuracy, three-prong water bath clamp and stand, pipet bulb, beaker.

Procedure: The procedure is as follows:
1. Set the water bath to 25° C.
2. Choose appropriate viscometer which is defined by the product work instructions.
3. Place viscometer in a beaker. Place both on balance and tare. Add approximately 7-8 grams of sample.
4. Place viscometer in the water bath and ensure the sample is immersed below the water level.
5. Allow the sample and viscometer to equilibrate with the water bath for 5-6 min.
6. Using the pipet bulb, apply suction to the smaller tube and draw the sample solution beyond the upper calibration mark. Allow sample to flow freely to get rid of air bubbles that might be in the tube.
7. With the stopwatch measure the efflux time for the sample meniscus to pass from the upper calibration mark to the lower one.
8. Viscosity evaluations should be run in triplicate. The runs should agree within ±5%.
9. Results are calculated by using the formula:
   Viscosity in Centistokes=K*T
   K—viscosity constant
   T—efflux time in seconds.
      Measurement of Bleaching Parameters

The % Initial Transmission for the coated composition is less than or equal to about 20%, preferably less than or equal to 17%. The % Final Transmission for the coated composition is greater than or equal to about 80%, preferably greater than or equal to about 90%.

The Transmission % (initial and final) are determined as follows. The purpose of this test is to obtain bleaching parameters for CEM products.

Equipment and Materials: OAI 357 Stepper Exposure Analyzer, Oriel shutter control and Hg Lamp, 365 nm, 405 nm, and/or 436 nm Filter, SVG Site Coater, Glass wafer, and Cary 50 UV-Vis/.

Procedure: The procedure is as follows:
1. Turn on the power for Oriel Arc lamp.
2. Push the lamp start button until the Hg lamp is ignited. The lamp may need a minimum of 15 min. to warm up.
3. Turn on the filter cooling fan.
4. Place appropriate Filter (436 G-line, 405 F-line, 365 I-line) in the filter holder.
5. Check the light intensity if necessary.
6. Turn the OAI on and press the Start button and then press the I button.
7. Choose the appropriate wavelength probe.
8. Place the probe on the plastic sample holder and note the value.
9. Select the General Bleach Curve Method, and set the appropriate wavelength and time.
10. Place a blank glass wafer in the sample holder.
11. Coat the glass wafer on the SVG site coater according to the appropriate product requirements.
12. Place coated wafer in the sample holder.
13. Measure Initial Transmission value.
14. Repeat for Final Transmission.
15. Calculate Bleach Rate.
   Determination of Thickness

Thickness is measured to establish a baseline for process set up. The thickness is determined based on spin speed of the wafer. The CEM material can be coated at several different speeds to determine the slope of the curve and the ideal setting for each application.

Equipment and materials: Nanospec Optical Instrument, clean 4″ silicon wafers, site coater coating machine, silicon check wafer, and eppendorf pipettor with appropriate tips.

Procedure: The procedure is as follows:
1 Perform system verification using the Silicon check wafer.
2 If lamp is off, it must be warmed up for 30 min. prior to use.
3. Set wavelength to 480.
4. Rotate Lens Turret and focus on bare Silicon wafer.
5. Measure bare Silicon wafer.
5. Coat bare Silicon water from with CEM.
6. Place coated wafer under the lens.
7. Focus on the coated sample and measure.
8. Take 5 readings for each wafer in the positions shown:

$$\begin{matrix} & 1 & \\ 4 & 2 & 5 \\ & 3 & \end{matrix}$$

Determination of Particles

A low particle size is important to the performance of the product. Contamination can inhibit the ability to coat a wafer. The amount of particles having a size of less than or equal to 0.5 μm should be less than about 75 particles/mL, preferably less than or equal to 50 particles/mL, most preferably less than 40 particles/mL.

The purpose of the following steps is to measure the particles in liquid materials.

Equipment and Materials: Rion Particle Counter, D.I. Water, Isopropanol, and Nitric Acid.

Procedure
1. Check syringe sampler to see if it is in good condition (no cracks, no cloudy material in syringe).
2. Turn power on particle counter.
3. Set program particle size at 0.5.
4.0 For water-based materials:
   4.1 Flush system with filtered DI water.
   4.2. Insert bottled product to be measured, wipe off sample hose to avoid contamination, flush with product, then run sample three times to get particle average per mil after results are stable;
   4.3. Clean system with D.I. water before transferring sample hose to different materials.
5.0 For Organic solvent-based materials
   5.1. Flush system with IPA.
   5.2. Insert bottled product to be measured, wipe off sample hose to avoid contamination, flush with product, then run sample three times to get particle average per mil after results are stable;
   5.3 Clean the system with IPA before transferring sample hose to different material.
6.0 Leave system filled with IPA or DI water when not in use to avoid drying out the cell.
7.0 For maintenance, the particle counter cell should be cleaned once a month with Nitric Acid; or as needed if counts are abnormally high. Flush with large volumes of DI water to avoid reactions.
   Determination of Trace Metals

As discussed above, in some instances, it is beneficial to lower the amounts of metal ions present in the present composition. For instance, it is sometimes beneficial to reduce the amounts of sodium and/or iron to less than or equal to 600 ppb, preferably less than about 500 ppb. The reduction of metals in the water-based products reduces the effects of metal layer corrosion.

The purpose of the following steps is to determine the trace metal level in materials.

References: Trace Metal Standard Solution Preparation, and Varian SpectrAA Operation Manual

Equipment and Material: SpectrAA 220Z, GTA Accessory, Computer and Monitor, Argon (Ultra-Pure Carrier Grade), D.I. water, Standard solution, 2 mL Sample Cups, Water Pump and Bath, Kim Wipes, Matrix Modifier (1000 ppm Pd in 1% Citric Acid), Dilute nitric acid (HNO3), Methanol, and Cotton Swab

Procedure:
1. Turn on Argon gas cylinder (30 psi recommended).
2. Turn on Water Pump.
3. Turn on GTA Accessory, SpectrAA 220Z, computer, and monitor.
4. Open SpectrAA software by double clicking ‘SpectrAA’ icon on the desktop. Click on ‘Worksheet’ button.
5. Click on ‘New From’ button, and select desired method. Name the file and click ‘OK’.
6. Use ‘Furnace Facilities’ button to check tip alignment, condition tube, and rinse capillary. See the Preventative Maintenance section to determine what checks are to be performed.
7. Use ‘Optimize’ button to check lamp alignment. Choose lamp to optimize by selecting desired element, then click ‘OK’. Adjust lamp intensity using thumbscrews at the back of the lamp housing. Click ‘OK’, then ‘Cancel’ when maximum intensity is achieved.
8. Click on ‘Labeling’ tab to type in sample name(s). This generally will be the lot number of the sample(s) to be analyzed.
9. Click on ‘Analysis’ tab to set up the sample sequence. Use the Sequence highlighter to select sample(s) to be run.
10. Prepare trace metals standards.
11. Once preventative maintenance is complete, samples have been poured and placed in the appropriate location of the autosampler tray, press the ‘Start’ button.
12. Upon completion of run, record results from the printed report.
13. Shut off all equipment.
14. For preventative maintenance, daily (or upon use): inspect the graphite tube for wear, corrosion, or etching. Replace when needed. Check the capillary tip alignment with the graphite furnace. Make sure the tip is not bent or damaged. If necessary cut the capillary tip at a right angle and realign with the furnace. Wipe any excess sample from the capillary tip using a Kim wipe and dilute nitric acid. See the instructions in the Varian SpectrAA Operation Manual for information on replacing the capillary assembly. Weekly, using a cotton swab, clean the graphite shroud to remove loose carbon or sample residues. Clean quartz windows using methanol and a Kim wipe. Make sure to remove any excess methanol to prevent spots on the window. Inspect water and gas hoses for damage. Turn on water and gas supplies, and test all hoses and connections for leaks. Replace any damaged hoses.

The following examples are provided for a further understanding of the invention, however, the invention is not to be construed as limited thereto.

### EXAMPLES

Examples 1-7 are water-based compositions, Examples 8-14 are solvent-based compositions and Examples 15 and 16 relate to shelf life studies for certain water- and solvent-based systems.

### Example 1

### CEM3651S

Example 1 is a water-based CEM composition. The ingredients are as follows:

| Ingredients | Amounts (kg) |
|---|---|
| DABCO (diazabicyclo octane) CAS 280-57-9 | 0.018 |
| Deionized (DI) Water | 0.857 |
| Surfynol ™ 465 | 0.004 |
| Kathon | 0.001 |
| Luviskol ™ VA-64 | 0.082 |
| Nitrone 408 | 0.041 |

To prepare, the DI water and Luviskol™ VA-64 are weighed and placed in a stainless steel can, which has been pre-rinsed three times prior to adding the ingredients. The Luviskol™ VA-64 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals. The amounts should be below 500 ppb. Next, the Nitrone 408, DABCO, Surfynol™ 465, and Kathon are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 2

### CEM36510

Example 2 is a water-based CEM composition. The ingredients are as follows:

| Ingredients | Amounts (kg) |
|---|---|
| DABCO (diazabicyclo octane) CAS 280-57-9 | 0.020 |
| DI Water | 0.906 |
| Surfynol ™ 465 | 0.004 |
| Kathon | 0.001 |
| Luviskol ™ VA-64 | 0.028 |
| Nitrone 408 | 0.044 |

To prepare, the DI water and Luviskol™ VA-64 are weighed and placed in a stainless steel can, which has been pre-rinsed three times prior to adding the ingredients. The Luviskol™ VA-64 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals. The amounts should be below 500 ppb. Next, the Nitrone 408, DABCO, Surfynol™ 465, and Kathon are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 3

### CEM3651M

Example 3 is a water-based CEM composition. The ingredients are as follows:

| Ingredients | Amounts (kg) |
|---|---|
| DABCO (diazabicyclo octane) CAS 280-57-9 | 0.009 |
| DI Water | 0.978 |
| Surfynol ™ 465 | 0.004 |
| Ion Exchange Resin IRN-150 | 0.047 |
| Pullan PI20 | 0.056 |
| Nitrone 409 | 0.020 |

To prepare, the DI water and Pullan P120 are weighed and placed in a stainless steel can, which has been pre-rinsed three times prior to adding the ingredients. The PullanPI20 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals. To bring the amounts below 500 ppb, the ion exchange resin is used. Next, the Nitrone 409, DABCO, and Surfynol™ 465 are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 4

### CEM3651H

Example 4 is a water-based CEM composition. The ingredients are as follows:

| Ingredients | Amounts (kg) |
|---|---|
| DABCO (diazabicyclo octane) CAS 280-57-9 | 0.008 |
| DI Water | 0.906 |
| Surfynol ™ 465 | 0.004 |
| Kathon | 0.001 |
| Pullan PI20 | 0.066 |
| Nitrone 409 | 0.019 |

To prepare, the DI water and Pullan P120 are weighed and placed in a stainless steel can, which has been pre-rinsed three times prior to adding the ingredients. The Pullan P120 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals to ensure that the amounts are below 500 ppb. Next, the Nitrone 409, DABCO, Surfynol™ 465, and Kathon are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 5

### CEM3651B

Example 5 is a water-based CEM composition. The ingredients are as follows:

| Ingredients | Amounts (kg) |
|---|---|
| DABCO (diazabicyclo octane) CAS 280-57-9 | 0.018 |
| DI Water | 0.840 |
| Surfynol ™ 465 | 0.004 |
| Kathon | 0.001 |
| Luviskol ™ VA-64 | 0.085 |
| Nitrone 408 | 0.045 |

To prepare, the DI water and Luviskol™ VA-64 are weighed and placed in a stainless steel can, which has been pre-rinsed three times prior to adding the ingredients. The Luviskol™ VA-64 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals to ensure that the amounts are below 500 ppb. Next, the Nitrone 408, DABCO, Surfynol™ 465, and Kathon are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 6

### CEM365HR

Example 6 is a water-based CEM composition. The ingredients are as follows:

| Ingredients | Amounts (kg) |
|---|---|
| DABCO (diazabicyclo octane) CAS 280-57-9 | 0.020 |
| DI Water | 0.906 |
| Surfynol ™ 465 | 0.004 |
| Kathon | 0.001 |
| Luviskol ™ VA-64 | 0.028 |
| Nitrone 408 | 0.044 |

To prepare, the DI water and Luviskol™ VA-64 are weighed and placed in a stainless steel can, which has been pre-rinsed three times prior to adding the ingredients. The Luviskol™ VA-64 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals to ensure that the amounts are below 500 ppb. Next, the Nitrone 408, DABCO, Surfynol™ 465, and Kathon are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 7

### CEM3651BB

Example 7 is a water-based CEM composition. The ingredients are as follows:

| Ingredients | Amounts (kg) |
|---|---|
| DABCO (diazabicyclo octane) CAS 280-57-9 | 0.017 |
| DI Water | 0.813 |
| Surfynol ™ 465 | 0.004 |
| Kathon | 0.001 |
| Luviskol ™ VA-64 | 0.079 |
| Nitrone 408 | 0.039 |

To prepare, the DI water and Luviskol™ VA-64 are weighed and placed in a stainless steel can, which has been pre-rinsed three times prior to adding the ingredients. The Luviskol™ VA-64 is added at a slow rate to avoid clumping. Next, the mixture is stirred with an air driven stirrer (overhead, air driven stirrer with stainless steel shaft and agitator) for at least 1 hour. Aluminum foil is used to cover the lid of the can during mixing.

After the foam settles, the sample is tested for trace metals to ensure that the amounts are below 500 ppb. Next, the Nitrone 408, DABCO, Surfynol™ 465, and Kathon are weighed and added to the can, in this order. Since the Nitrone is a light sensitive material, yellow light is used, not white light, when working with this product.

Next, the mixture is stirred for 1 hour. Again, aluminum foil is used to cover the lid of the can during mixing. After the foam settles, a sample is tested for thickness. To bring the thickness to proper amounts, DI water is added.

### Example 8

### CEM420WSF

Example 8 is an organic solvent-based CEM composition. The ingredients are as follows:

| Ingredients | Amounts (kg) |
|---|---|
| Ethyl Benzene | 0.312 |
| n-Butanol | 0.567 |
| FC-4430 FLUORAD ™ | 0.004 |
| Luviskol ™ VA-64 | 0.060 |
| Molecular Sieves 1/16 | 0.050 |
| Nitrone 420B | 0.030 |
| Nitrone 420E | 0.030 |

To prepare, the ethyl benzene and n-butanol are weighed and added to a stainless steel can. An air driven stirrer is turned on to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrones (420B and 420E) and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried using the molecular sieves until the water content falls below 400 ppm. After drying, a sample is tested for thickness. To provide proper thickness, the sample is suitably diluted with the combined solvents.

### Example 9

### CEM420WS

Example 9 is an organic solvent-based CEM composition. The ingredients are as follows:

| Ingredients | Amounts (kg) |
|---|---|
| Ethyl Benzene | 0.414 |
| n-Butanol | 0.414 |
| FC-4430 FLUORAD ™ | 0.004 |
| Luviskol ™ VA-64 | 0.085 |
| Molecular Sieves 1/16 | 0.050 |
| Nitrone 420B | 0.041 |
| Nitrone 420E | 0.041 |

To prepare, the ethyl benzene and n-butanol are weighed and added to a stainless steel can. An air driven stirrer is turned on to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrones (420B and 420E) and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried using the molecular sieves until the water content falls below 400 ppm. After drying, a sample is tested for thickness. To provide proper thickness, the sample is suitably diluted with the combined solvents.

### Example 10

### CEM388PG

Example 10 is an organic solvent-based CEM composition. The ingredients are as follows:

| Ingredients | Amounts (kg) |
|---|---|
| Isopropanol Pure | 0.041 |
| PGMEA (propylene glycol methyl ether acetate) | 0.771 |
| FC-4430 FLUORAD ™ | 0.001 |
| Luviskol ™ VA-64 | 0.093 |
| Molecular Sieves 1/16 | 0.050 |
| Nitrone 388 | 0.095 |

To prepare, the PGMEA and isopropanol are weighed and added to a stainless steel can. An air driven stirrer is turned to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrone 388 and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried using the molecular sieves until the water content falls below 400 ppm. After drying, a sample is tested for thickness. To provide proper thickness, the sample is suitably diluted with the combined PGMEA and isopropanol solvents.

### Example 11

### CEM388SS

Example 11 is an organic solvent-based CEM composition. The ingredients are as follows:

| Ingredients | Amounts (kg) |
|---|---|
| Isopropanol Pure | 0.050 |
| PGMEA (propylene glycol methyl ether acetate) | 0.700 |
| FC-4430 FLUORAD ™ | 0.001 |
| Luviskol ™ VA-64 | 0.150 |
| Molecular Sieves 1/16 | 0.050 |
| Nitrone 388 | 0.098 |

To prepare, the PGMEA and isopropanol are weighed and added to a stainless steel can. An air driven stirrer is turned to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrone 388 and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried using the molecular sieves until the water content falls below 400 ppm. After drying, a sample is tested for thickness. To provide proper thickness, the sample is suitably diluted with the combined PGMEA and isopropanol solvents.

### Example 12

### CEM388WS

Example 12 is an organic solvent-based CEM composition. The ingredients are as follows:

| Ingredients | Amounts (kg) |
|---|---|
| Ethyl Benzene | 0.416 |
| n-Butanol | 0.416 |
| FC-4430 FLUORAD ™ | 0.004 |
| Luviskol ™ VA-64 | 0.084 |
| Molecular Sieves 1/16 | 0.050 |
| Nitrone 388 | 0.082 |

To prepare, the ethyl benzene and n-butanol are weighed and added to a stainless steel can. An air driven stirrer is turned on to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrone 388 and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried with the molecular sieves until the water content falls below 400 ppm. After drying, a sample is tested for thickness. To provide proper thickness, the sample is suitably diluted with the combined ethyl benzene and n-butanol solvents.

### Example 13

### CEM365WSHR

Example 13 is an organic solvent-based CEM composition. The ingredients are as follows:

| Ingredients | Amounts (kg) |
|---|---|
| Ethyl Benzene | 0.463 |
| n-Butanol | 0.463 |
| FC-4430 FLUORAD ™ | 0.003 |
| Luviskol ™ VA-64 | 0.015 |
| Molecular Sieves 1/16 | 0.040 |
| Nitrone 388 | 0.058 |

To prepare, the ethyl benzene and n-butanol are weighed and added to a stainless steel can. An air driven stirrer is turned on to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrone 388 and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried with the molecular sieves until the water content falls below 400 ppm. After drying, a sample is tested for thickness. To provide proper thickness, the sample is suitably diluted with the combined solvents.

### Example 14

### CEM365WS

Example 14 is an organic solvent-based CEM composition. The ingredients are as follows:

| Ingredients | Amounts (kg) |
|---|---|
| Ethyl Benzene | 0.461 |
| n-Butanol | 0.461 |
| FC-4430 FLUORAD ™ | 0.003 |
| Luviskol ™ VA-64 | 0.018 |
| Molecular Sieves 1/16 | 0.040 |
| Nitrone 388 | 0.058 |

To prepare, the ethyl benzene and n-butanol are weighed and added to a stainless steel can. An air driven stirrer is turned to begin mixing the ingredients. Next, the Luviskol™ VA-64 is weighed and added. Next, the mixture is stirred with an air driven stirrer (overhead, air driven stirrer with stainless steel shaft and agitator) for at least 1 hour. Aluminum foil is used to cover the lid of the can during mixing.

Next, the Nitrone 388 and FC-4430 FLUORAD™ (in this order) are weighed and added to the can. Since the Nitrone is a light sensitive material, yellow light is used, not white light, when working with this product. Next, the mixture is stirred for 1 hour. Again, aluminum foil is used to cover the lid of the can during mixing.

Next, the material is dried with the molecular sieves until the water content falls below 400 ppm. After drying, a sample is tested for thickness. To provide proper thickness, the sample is suitably diluted with the combined ethyl benzene and n-butanol solvents.

### Example 15

The shelf life experiment consisted of three batches of water-based CEM. The composition of the water-based CEM was prepared by following the directions of Example. The experimental batches were stored at both process temperature (18° C.-24° C., 65° F.-75° F.) and storage temperature (2° C.-4° C., 35° F.-41° F.). The three experimental batches were tested with a sample of storage temperature material and process temperature material. The tests were conducted each month and the results of the tests were compared to product specifications.

Shelf Life Study for Water-Based CEM

| Batch | Thickness | SD Thickness | Viscosity | % Solids | pH | Ini. Trans. | Final Trans. |
|---|---|---|---|---|---|---|---|
| 1 | 1796 | 40.5 | 2 | 8.5 | 8.7 | 14.59 | 87.39 |
| 2 | 1862 | 34.2 | 2 | 8.7 | 8.8 | 13.53 | 88.27 |
| 3 | 1887 | 29.5 | 2 | 8.7 | 8.9 | 13.68 | 88.19 |

T = 3/3/03

| | | | | | | | |
|---|---|---|---|---|---|---|---|
| 1 | 1667 | 91.5 | 2 | 8.7 | 8.5 | 14.57 | 86.73 |
| 2 | 1592 | 45.3 | 2 | 8.4 | 8.5 | 14.15 | 86.41 |
| 3 | 1759 | 75.7 | 2 | 8.5 | 8.5 | 13.91 | 86.54 |

T = 3/19/03

| | | | | | | |
|---|---|---|---|---|---|---|
| 1 | 1629 | 45.4 | 2 | 8.47 | 14.4856 | 86.264 |
| 2 | 1656 | 38.6 | 2 | 8.48 | 13.1282 | 86.2366 |
| 3 | 1623 | 60.2 | 2 | 8.51 | 14.8547 | 85.9412 |

T = 34/23/03

| | | | | | | | |
|---|---|---|---|---|---|---|---|
| 1 | 1695 | 74.1 | 2 | | 8.32 | 14.41 | 85.31 |
| 2 | 1762 | 64 | 2.1 | 8.7 | 8.35 | 14.2 | 84.84 |
| 3 | 1741 | 55.5 | 2.1 | | 8.36 | 14.62 | 85.52 |

T = 5/15/2003

| | | | | | | | |
|---|---|---|---|---|---|---|---|
| 1 | 1684 | 28.9 | 2 | | 8.21 | 15.65 | 84.47 |
| 2 | 1581 | 24.4 | 2.1 | 8.6 | 8.22 | 16.38 | 84.46 |
| 3 | 1520 | 61.8 | 2.1 | | 8.23 | 14.58 | 83.98 |

T = 6/24/2003

| | | | | | | | |
|---|---|---|---|---|---|---|---|
| 1 | 1842 | 38.9 | 2.1 | | 8.25 | 14.96 | 83.04 |
| 2 | 1868 | 41.3 | 2.1 | 8.3 | 8.27 | 14.55 | 82.67 |
| 3 | 1854 | 48.9 | 2.1 | | 8.27 | 14.79 | 83.02 |

T = 7/21/2003

| | | | | | | | |
|---|---|---|---|---|---|---|---|
| 1 | 1752 | 48.5 | 2 | | 8.17 | 16.96 | 83.5 |
| 2 | 1770 | 49.9 | 2 | 8.6 | 8.18 | 15.71 | 82.4 |
| 3 | 1767 | 48.9 | 2.1 | | 8.19 | 16.19 | 83.13 |

T = 8/19/2003

| | | | | | | | |
|---|---|---|---|---|---|---|---|
| 1 | 1766 | 50.5 | 2 | | 8.15 | 16.66 | 82.1 |
| 2 | 1784 | 60.6 | 2 | 8.3 | 8.19 | 16.21 | 81.64 |
| 3 | 1827 | 54.1 | 2 | | 8.2 | 16.69 | 81.76 |

T = 9/24/2003

| | | | | | | | |
|---|---|---|---|---|---|---|---|
| 1 | 1760 | 37.3 | 2 | | 8.02 | 17.28 | 80.69 |
| 2 | 1731 | 43.9 | 2 | 8.3 | 8.04 | 17.68 | 80.61 |
| 3 | 1744 | 41 | 2 | | 8.03 | 18.06 | 80.88 |

### Example 16

The shelf life experiment consisted of three batches of solvent-based CEM. The composition of the solvent-based CEM was prepared by following the directions of Example 11. The experimental batches were stored at both process temperature (18° C.-24° C., 65° F.-75° F.) and storage temperature (2° C.-4° C., 35° F.-41° F.). The three experimental batches were tested with a sample of storage temperature material and process temperature material. The tests were conducted each month and the results of the tests were compared to product specifications.

Shelf Life Study for Solvent-Based CEM

| | | | | | | |
|---|---|---|---|---|---|---|
| | | SD | | % | Ini. | Final |
| Batch | Thickness | Thickness | Viscosity | Solids | Trans. | Trans. |

Initial Results(3-26-2003)

| | | | | | | |
|---|---|---|---|---|---|---|
| 1 | 1.5358 | 213.1 | 17.9 | 24.4 | 0.15 | 93.21 |
| 2 | 1.54 | 236.8 | 15.2 | 23 | 0.15 | 94.91 |
| 3 | 1.5009 | 69.5 | 17.7 | 23.9 | 0.0102 | 93.18 |

Month 1(4-24-2003)

| | | | | | | |
|---|---|---|---|---|---|---|
| 1 | 1.5306 | 119.4 | 18.2 | | 0.16 | 94.01 |
| 2 | 1.5396 | 193.6 | 16.1 | 22.9 | 0.17 | 93.32 |
| 3 | 1.5631 | 169.9 | 17.9 | | 0.16 | 92.7 |

Month 2(5-29-2003)

| | | | | | | |
|---|---|---|---|---|---|---|
| 1 | 1.5752 | 260.4 | 17.9 | | 0.16 | 93.21 |
| 2 | 1.5482 | 286.8 | 16.1 | 22.9 | 0.16 | 93.76 |
| 3 | 1.5419 | 148.5 | 17.7 | | 0.16 | 93.65 |

Month 3(6-24-2003)

| | | | | | | |
|---|---|---|---|---|---|---|
| 1 | 1.531 | 274.1 | 17.9 | | 0.16 | 90.42 |
| 2 | 1.4883 | 161.6 | 16.2 | 23 | 0.16 | 91.23 |
| 3 | 1.4982 | 206.7 | 17.7 | | 0.14 | 91.14 |

Month 4(7-22-2003)

| | | | | | | |
|---|---|---|---|---|---|---|
| 1 | 1.5387 | 248.1 | 18 | | 0.16 | 93.36 |
| 2 | 1.4997 | 450.3 | 16.2 | 22.8 | 0.16 | 94.21 |
| 3 | 1.487 | 65.1 | 17.8 | | 0.16 | 94.11 |

Month 5(8-26-2003)

| | | | | | | |
|---|---|---|---|---|---|---|
| 1 | 1.5827 | 175.6 | 18 | | 0.16 | 92.16 |
| 2 | 1.5033 | 453 | 16.3 | 22.8 | 0.17 | 93.95 |
| 3 | 1.5491 | 267.7 | 17.8 | | 0.16 | 93.33 |

Month 6(9-24-2003)

| | | | | | | |
|---|---|---|---|---|---|---|
| 1 | 1.5706 | 252.7 | 18 | | 0.15 | 92.09 |
| 2 | 1.4878 | 316.7 | 16.2 | 22.5 | 0.16 | 94.04 |
| 3 | 1.5594 | 127.8 | 17.8 | | 0.16 | 92.83 |

All cited patents, publications, co-pending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A contrast enhancement layer composition, comprising:
(A) a photobleachable dye;
(B) an organic polymer binder;
(C) a surfactant, which does not contain perfluorooctanyl sulfonate (PFOS); and
(D) a solvent.

2. The composition according to claim 1, wherein said photobleachable dye is a nitrone.

3. The composition according to claim 1, wherein said solvent is water and said surfactant is a nonionic surfactant.

4. The composition according to claim 1, wherein said solvent is water and said surfactant is at least one selected from the group consisting of polyoxyethylene alcohol, tristyrylphenol, nonyl or octyl phenol, ester, diester, sorbitol ester, polyoxyethylene/propylene block copolymer, sorbitan fatty acid ester, polyoxyethylene sorbitan fatty acid ester, ethoxylated siloxane, acetylenic diol, and polyglucoside.

5. The composition according to claim 1, wherein said solvent is water and said surfactant is an ethoxylated acetylenic diol.

6. The composition according to claim 5, wherein said ethoxylated acetylenic diol is ethoxylated 2,4,7,9-tetramethyl-5-decyn-4,7-diol.

7. The composition according to claim 5, wherein said solvent is at least one organic solvent and said surfactant is FC-4430 Fluororad™ Fluorosurfactant.

8. The composition according to claim 7, wherein said organic solvent is at least one of an aromatic hydrocarbon, aliphatic hydrocarbon, halogenated aliphatic compound, or an alcohol.

9. The composition according to claim 7, wherein said organic solvent is at least one selected from the group consisting of toluene, xylene, ethylbenzene, chorobenzene, cyclohexane, trichloroethylene, methyl chloroform, 1,2-dimethoxy ethane, di-(2-methoxy ethyl)ether, 1-methoxy-2-propyl acetate, 1,1,2,2-tetrachloroethane, 1-methoxy-2-ethyl acetate, dioxane, methylisobutyl ketone, cyclohexanone, butanol, propanol, ethylene glycol, propylene glycol, amylacetate, butylacetate, toluene and propylene glycol methyl ether acetate (PGMEA).

10. The composition according to claim 7, wherein said organic solvent is a combination of ethyl benzene and n-butanol.

11. The composition according to claim 7, wherein said organic solvent is a combination of isopropanol and propylene glycol methyl ether acetate (PGMEA).

12. The composition according to claim 1, further comprising a drying agent.

13. The composition according to claim 1, further comprising a biocide.

14. The composition according to claim 1, wherein said composition retains 95% of its bleaching activity when stored at 20° C. for at least 90 days.
